(19) United States
(12) Patent Application Publication
(10) Pub. No.: US 2022/0324524 A1
(43) Pub. Date: Oct. 13, 2022

(54) Fifth Wheel Lubricant Applicator Tool, Kit, and Method of Use

(71) Applicant: Mark ANDERSON, Bergen, NY (US)

(72) Inventors: Mark ANDERSON, Bergen, NY (US); Eric Paul ROSE, Tarzana, CA (US)

(73) Assignee: Mark ANDERSON, Bergen, NY (US)

(21) Appl. No.: 17/712,637

(22) Filed: Apr. 4, 2022

Related U.S. Application Data
(60) Provisional application No. 63/177,646, filed on Apr. 21, 2021.
(60) Provisional application No. 63/174,108, filed on Apr. 13, 2021.

(51) Int. Cl. B62D 53/08

(52) U.S. Cl. CPC B62D 53/0885

(57) ABSTRACT

A fifth wheel lubricant applicator tool, kit, and method of use are disclosed. The lubricant applicator tool comprises a handle portion and an operative portion. The handle portion has a first width and a defined length. The operative portion extends out from the defined length of the handle portion such that a second width of the operative portion remains less than a length of the lubricant applicator tool. The operative portion comprises a working edge equipped with a plurality of indentations that are identical and evenly spaced. The width and the height of each of the plurality of indentations permits an application of a lubricant in parallel beads, each spaced apart from adjacent beads by a defined distance that is substantially same as a distance between two adjacent indentations.

### CROSS-REFERENCE TO RELATED APPLICATIONS

This application claims benefit of and priority to U.S. Provisional Patent Application No. 63/174,108, filed Apr. 13, 2021, and U.S. Provisional Patent Application No. 63/177,646, filed Apr. 21, 2021, the contents of each are incorporated by reference in their entireties.

### FIELD OF THE DISCLOSURE

The present invention relates to a lubricant applicator, and more specifically, to a fifth wheel lubricant applicator tool, kit, and method of use.

### BACKGROUND OF THE INVENTION

Specialized powered vehicles, such as a semi-trucks, are used to pull unpowered vehicles, such as trailers, for transportation of goods, materials, and other items for various purposes. A powered vehicle may be equipped with a device, referred to as a fifth wheel mechanism, and an unpowered vehicle may have a king pin and a plate mounted on the underside of the unpowered vehicle. The fifth wheel may be coupled to the unpowered vehicle as the king pin is secured in a recess provided in the fifth wheel and the facing surfaces of the fifth wheel and the plate mate with each other. Such a coupling allow the mating surfaces to rotate relative to each other in a horizontal plane to further allow the powered vehicle to turn relative to the unpowered vehicle.

For obvious reasons, the mating surfaces must be adequately lubricated to minimize wear-and-tear and friction, since such surfaces are constantly rotating against each other. However, when the mating surfaces are coupled when the two vehicles are engaged, the lubricant is often wiped away from the surfaces. In other cases, the powered vehicle is often driven alone or left in exposed locations due to which the lubricant on the fifth wheel is washed away or becomes contaminated with foreign objects, such as dust, rocks, and the like. This may increase the friction between the mating surfaces, which is uncalled for.

Currently, various methods for lubricating the fifth wheel are being deployed. One method is to apply the lubricant on the fifth wheel manually. However, such manual application may be tricky as the amount of lubricant to apply is not always easy to determine because of insufficient expertise of a user (i.e. a driver or a mechanic) or other factors, such as poor visibility during night hours. Other means of lubricating the fifth wheel may be using a grease gun and spreading the grease on the surface of the fifth wheel prior to the coupling of the two vehicles. However, this method is messy, inconvenient, and time consuming. Also, safety is always an issue as the user carrying the grease gun has to climb onto the back of the vehicle and has to encounter cramped or close quarters to apply the lubricant on the fifth wheel.

In accordance with the existing methods at least stated above, either the amount of lubricant applied is in excess or is insufficient, thus leading to improper lubrication. In case of excess lubrication, overall expenditure and lubricant waste is increased, which is not desired. In case of insufficient lubrication, the friction between the mating surfaces may result in breakdowns, increased maintenance costs for repairs or replacements, or serious accidents with consequent danger to the user and damage to the vehicles. Thus, the existing methods of lubricating the fifth wheel are cumbersome, time consuming and inefficient. There is currently not a quick, effortless, clean, and convenient way to properly and completely lubricate the fifth wheel.

Still, there remains a continuing need for improved methods for lubricating the fifth wheels of powered vehicles.

### BRIEF SUMMARY OF THE PRESENT INVENTION

The present invention provides a fifth wheel lubricant applicator, kit, and method of use.

In one aspect of the present invention, the invention provides a lubricant applicator tool. The lubricant applicator tool comprises a handle portion with a first width and a defined length. The lubricant applicator tool further comprises an operative portion extending out from the defined length of the handle portion such that a second width of the operative portion remains less than a length of the lubricant applicator tool. The operative portion comprises a working edge equipped with a plurality of indentations that are identical and evenly spaced, a width and a height of each indentation ranging from 5 mm to 8 mm, and preferably from 6.3 mm to 6.4 mm. The width and the height of the plurality of indentations permits an application of a lubricant in parallel beads, each spaced apart from adjacent beads by a defined distance that is substantially same as a distance between two adjacent indentations.

In accordance with an embodiment, the lubricant applicator tool may be formed by injection molding.

In accordance with an embodiment, the lubricant applicator tool is formed of a synthetic plastic material.

In accordance with an embodiment, the lubricant applicator tool is in an elongated shape such that a length of the lubricant applicator tool is greater than a width of the lubricant applicator tool.

In accordance with an embodiment, the length of the lubricant applicator tool ranges from 120 mm to 130 mm.

In accordance with an embodiment, the second width of the operative portion at the working edge ranges from 70 mm to 80 mm.

In accordance with an embodiment, the lubricant applicator tool has a thickness that ranges from 3 mm to 3.5 mm.

In accordance with an embodiment, the working edge of the operative portion is tapered down towards an edge at a thickness that ranges from 1 mm to 2 mm.

In accordance with an embodiment, all corners of the lubricant applicator tool apart from the working edge are radiused and all edges of the lubricant applicator tool are rounded.

In accordance with an embodiment, the handle portion includes formations that facilitate gripping of the handle portion by a user.

In another aspect of the present invention, the invention provides a lubricant applicator kit. The lubricant applicator kit comprises a storage container adaptable to enclose a plurality of kit members. The plurality of kit members comprises a lubricant for lubricating a fifth wheel of a truck and a flexible pouch with a screw cap. The flexible pouch may be adapted to contain a defined quantity of the lubricant. The plurality of kit members further comprises a wiping member for cleaning drips-and-spills of the lubricant, and a pair of gloves adaptable to be worn by a user. The plurality of kit members further comprises a lubricant applicator tool comprising a handle portion and an operative portion extending out from the handle portion. The operative portion comprising a working edge equipped with a plurality of indentations (which may be identical and evenly spaced and have a width and height of each indentation ranging from preferably 5 mm to 8 mm, and more preferably from 6.3 mm to 6.4 mm). The width and the height of the plurality of indentations permits an application of the lubricant in parallel beads, each spaced apart from adjacent beads by a defined distance that is substantially same as a distance between two adjacent indentations.

In accordance with an embodiment, a storage container length and a storage container width range from 100 mm to 105 mm. A storage container height ranges from 150 mm to 155 mm.

In accordance with an embodiment, the pair of gloves is formed of plastic or latex material.

In accordance with an embodiment, wiping member length ranges from 300 mm to 305 mm, and a wiping member width ranges from 330 mm to 335 mm. The wiping member may be one of a wiping cloth, a rug, a paper towel, a paper wipe with multiple folds.

In accordance with an embodiment, the lubricant applicator kit further comprises an instructional guide for the user.

In accordance with an embodiment, the lubricant is a solid or semi-solid product of dispersion of a thickening agent in a lubricating oil and corresponds to a rim rust retardant and tire mounting lubricant.

In accordance with an embodiment, a spout of the flexible pouch is at least 10 mm, a capacity of the flexible pouch is at least 500 mL, and a flexible pouch height ranges from 140 mm to 150 mm.

In accordance with an embodiment, a shape of the plurality of indentations is one of a U-shaped rounded rectangle, an isosceles triangle, an isosceles trapezium, a semicircle, a rectangle, or a rectangle bordered by semi-circular corners.

In another aspect of the present invention, the invention provides a method of lubricating a fifth wheel of a truck. The method comprises cleaning a top surface of a coupling plate of the fifth wheel of the truck. The method further comprises squeezing out a lubricant from a flexible pouch on the top surface of the coupling plate. The method further comprises applying the lubricant on the top surface of the coupling plate by sliding a working edge of an operative portion of a lubricant applicator tool over the lubricant to form parallel beads, each spaced apart from adjacent beads by a distance between two adjacent indentations of a plurality of indentations of the working edge.

In accordance with an embodiment, the method further comprises wearing a pair of gloves by a user during one or more actions. The one or more actions comprise the cleaning of the top surface of the coupling plate, the squeezing out of the lubricant from the flexible pouch, and the application of the lubricant on the top surface.

In accordance with an embodiment, the method further comprises wiping, using a wiping member, drips-and-spills of the lubricant after the lubricant is applied on the top surface.

### BRIEF DESCRIPTION OF THE DRAWINGS

FIG. 1 depicts a block diagram and an elevational view of powered and unpowered vehicles, in accordance with an embodiment of the disclosure;

FIG. 2A depicts a first perspective view of decoupled powered and unpowered vehicles, in accordance with an embodiment of the disclosure;

FIG. 2B depicts a second perspective view of coupled powered and unpowered vehicles, in accordance with an embodiment of the disclosure;

FIG. 2C depicts a side view of the coupled powered and unpowered vehicles, in accordance with an embodiment of the disclosure.

FIG. 3 depicts a lubricant applicator kit that encloses a plurality of kit members, in accordance with an embodiment of the disclosure;

FIGS. 4A to 4C depict different views of the lubricant applicator tool, in accordance with an embodiment of the disclosure;

FIGS. 5A to 5C depict different views of the lubricant applied on a top surface of a fifth wheel, in accordance with an embodiment of the disclosure; and

FIG. 6 depicts a flowchart illustrating exemplary operations for lubricating a fifth wheel of a powered vehicle, in accordance with an embodiment of the disclosure.

### DETAILED DESCRIPTION OF EMBODIMENTS

The invention now will be described more fully hereinafter with reference to the accompanying drawings, in which embodiments of the invention are shown. This invention may however be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section.

It will be understood that the elements, components, regions, layers and sections depicted in the figures are not necessarily drawn to scale.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” “upper” or “top,” “left” or “right,” “above” or “below,” “front” or “rear,” may be used herein to describe one element's relationship to another element as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. The numbers, ratios, percentages, and other values may include those that are ±5%, ±10%, ±25%, ±50%, ±75%, ±100%, ±200%, ±500%, or other ranges that do not detract from the spirit of the invention. The terms about, approximately, or substantially may include values known to those having ordinary skill in the art. If not known in the art, these terms may be considered to be in the range of up to ±5%, ±10%, or other value higher than these ranges commonly accepted by those having ordinary skill in the art for the variable disclosed. Thus, embodiments of the present invention should not be construed as limited to the particular shapes of regions illustrated herein but are to include deviations in shapes that result, for example, from manufacturing. The invention illustratively disclosed herein suitably may be practiced in the absence of any elements that are not specifically disclosed herein. All patents, patent applications and non-patent literature cited through this application are hereby incorporated by reference in their entireties.

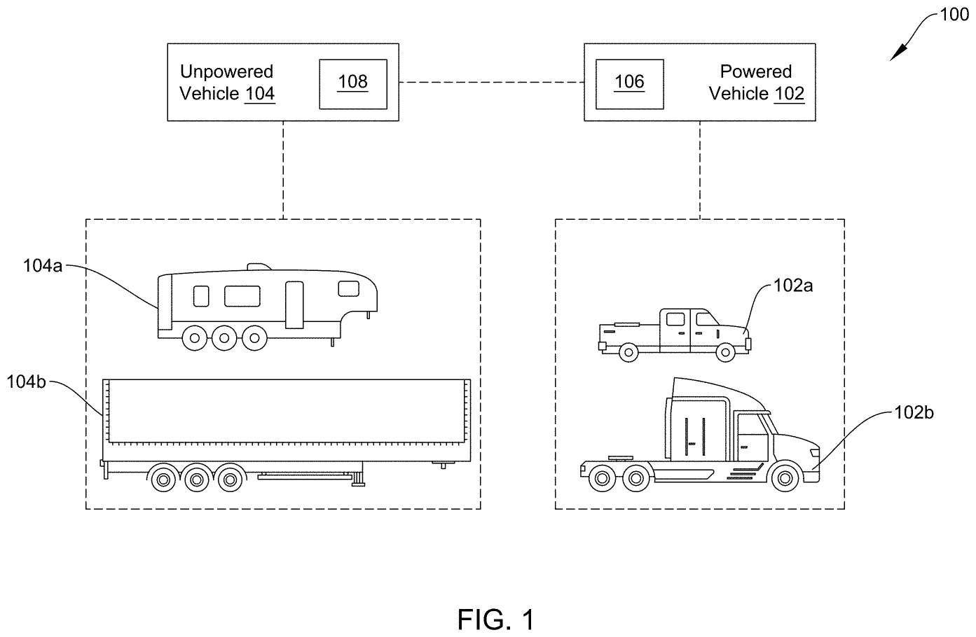

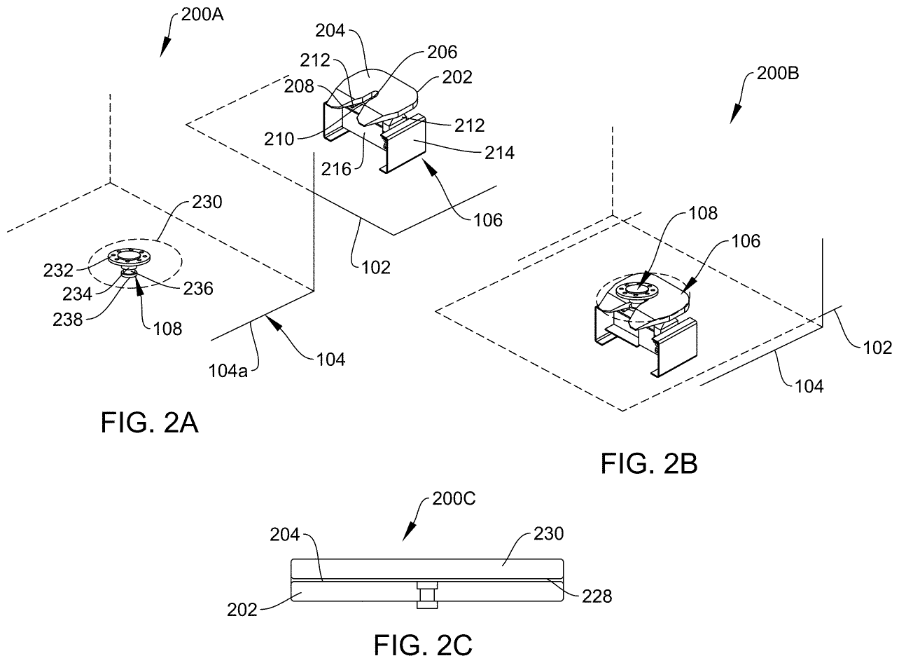

Turning to the Figures, FIG. 1 depicts a block diagram and an elevational view 100 of powered and unpowered vehicles, in accordance with an embodiment of the disclosure. FIG. 1 is described in conjunction with FIGS. 2A to 2C. FIG. 2A depicts a first perspective view 200A of a decoupled powered and unpowered vehicles, and FIG. 2B depicts a second perspective view 200B of coupled powered and unpowered vehicles. FIG. 2C depicts a rear view 200C of the coupled powered and unpowered vehicles, in accordance with an embodiment.

Referring to FIG. 1, there is shown a powered vehicle 102, such as a pickup truck 102a and a tractor unit 102b. There is also shown an unpowered vehicle 104, such as a travel trailer 104a and a semi-trailer 104b. The powered vehicle 102 may be equipped with a fifth wheel 106, and the unpowered vehicle 104 may include a king pin 108.

The powered vehicle 102 may correspond to a towing engine that provides motive power for hauling the unpowered vehicle 104. The powered vehicle 102 may be categorized as one of a light-duty, medium-duty, heavy-duty, or very-heavy duty powered vehicle. The light-duty powered vehicle, such as the pickup truck 102a, may have an enclosed cabin and an open cargo area with low sides and a tailgate. Such light-duty powered vehicle may be used for their hauling (utilizing cargo bed) and towing (utilizing body on frame design and long wheelbase) capabilities. The medium-duty and heavy-duty powered vehicles, such as commercial rear-wheel-drive semi-trailer truck or the tractor unit 102b, may be used for hauling semi-trailers. The very heavy-duty powered vehicles, such as ballast tractors, may be typically off-road-capable, often six-wheel drive, may be used for exceptionally heavy trailers. It should be noted that only two examples of the powered vehicle 102, i.e. the pickup truck 102a and the tractor unit 102b, have been shown in FIG. 1 for brevity. Other examples of the powered vehicle 102 may include a towing vehicle, truck, leading trailer, dolly, and/or the like, without any deviation from the scope of the disclosure.

The unpowered vehicle 104 may correspond to a container on wheels pulled or hauled by the powered vehicle 102 and is used to transport medium, large or heavy cargo. In one example, the travel trailer 104a may correspond to a house trailer or a mobile home for full-time recreational vehicle enthusiasts, who often live in them for several months in one place and use the towing vehicle, such as the pickup truck 102a, for running local errands. In another example, the semi-trailer 104b may be a trailer without a front axle and having legs to support them when they are not in use unlike a full trailer that has both the front and the rear axles, as well as a drawbar firmly attaching it to the hauling unit. Commercial freight trailers may be usually 40 feet long and may move vertically in relation to the hauling unit, which controls the direction of the front axle. It should be noted that only two examples of the unpowered vehicle 104, i.e. the travel trailer 104a and the semi-trailer 104b, have been shown in FIG. 1 for brevity. Other examples of the unpowered vehicle 104 may include a fifth-wheel trailer, full trailer, pop-up campers, and/or the like, without any deviation from the scope of the disclosure.

The fifth wheel 106 may be a horseshoe-shaped coupling device pivotally mounted on the open cargo area at the rear of the powered vehicle 102. As depicted in FIG. 2A, the fifth wheel 106 may include a body, referred to as a coupling plate 202, defined by a top surface 204 and a central opening, referred to as a recess 206. The coupling plate 202 may be provided with a V-shaped opening 208 at the rear end thereof and a blocking member 210. The V-shaped opening 208 may guide the king pin 108 to the central opening, i.e. the recess 206, of the fifth wheel 106 during coupling of the powered vehicle 102 with the unpowered vehicle 104.

The coupling plate 202 may be mounted on two bearing brackets 212 that may be arranged on two longitudinal seating brackets 214. The two longitudinal seating brackets 214 may be detachably mounted on the vehicle chassis frame of the powered vehicle 102 and arranged in the direction of travel. The two bearing brackets 212 in conjunction with the two longitudinal seating brackets 214 may provide a supportive seating for the coupling plate 202. The fifth wheel 106 may also include a transverse strut 216 arranged between the two longitudinal seating brackets 214.

The king pin 108 may be centrally mounted on an under surface plate 230 of a sub-floor of the unpowered vehicle 104, as depicted in FIG. 2A. The king pin 108 may include an upper port 232 which is affixed to the under surface plate 230 via a fastening means, such as welding. The king pin 108 extends downwards from the under surface plate 230 and includes a cylindrical base 234, a cylindrical shank 236 and a cylindrical head 238 with radially extending flange.

As depicted in FIG. 2B, in accordance with an embodiment, the king pin 108 may be engaged with the V-shaped opening 208 that guides the king pin 108 to the recess 206 of the fifth wheel 106 while the powered vehicle 102 is backing for coupling with the unpowered vehicle 104. Once engaged within the recess 206, the king pin 108 may be secured to the fifth wheel 106 by the blocking member 210. When the king pin 108 is to be disengaged from the recess 206 of the fifth wheel 106, the blocking member 210 may be retracted and the powered vehicle 102 may be driven away and decoupled from the unpowered vehicle 104.

In accordance with an embodiment, during coupling, the exposed surfaces of the fifth wheel 106 and the under surface plate 230 (that are facing each other) may mate with each other when the powered vehicle 102 is coupled with the unpowered vehicle 104, as depicted in the second perspective view 200B in FIG. 2B. More specifically, the top surface 204 of the fifth wheel 106 and the bottom surface 228 of the under surface plate 230 may mate with each other when the powered vehicle 102 is coupled with the unpowered vehicle 104, as depicted in the rear view 200C in FIG. 2C. Further, there is shown a layer of a lubricant 306 between the top surface 204 of the fifth wheel 106 and the bottom surface 228 of the under surface plate 230 in the rear view 200C.

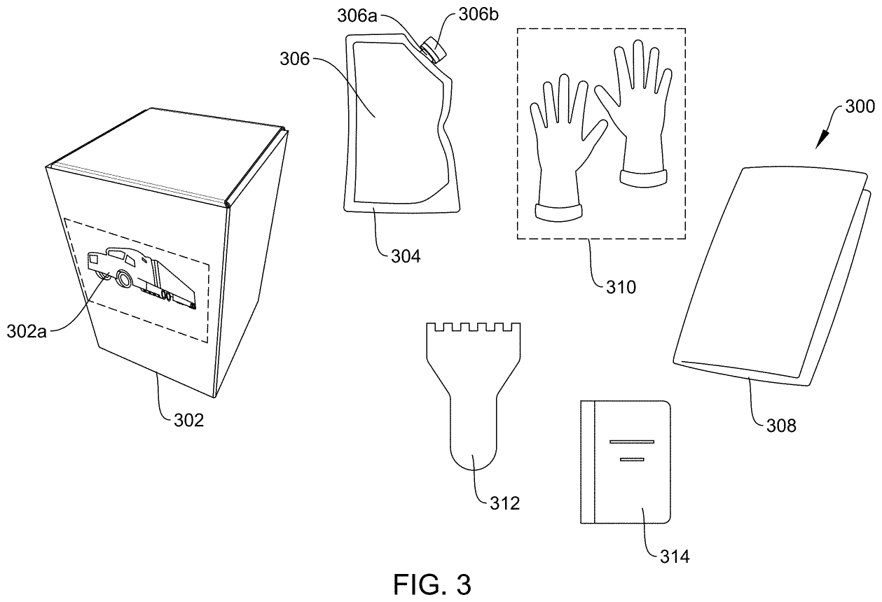

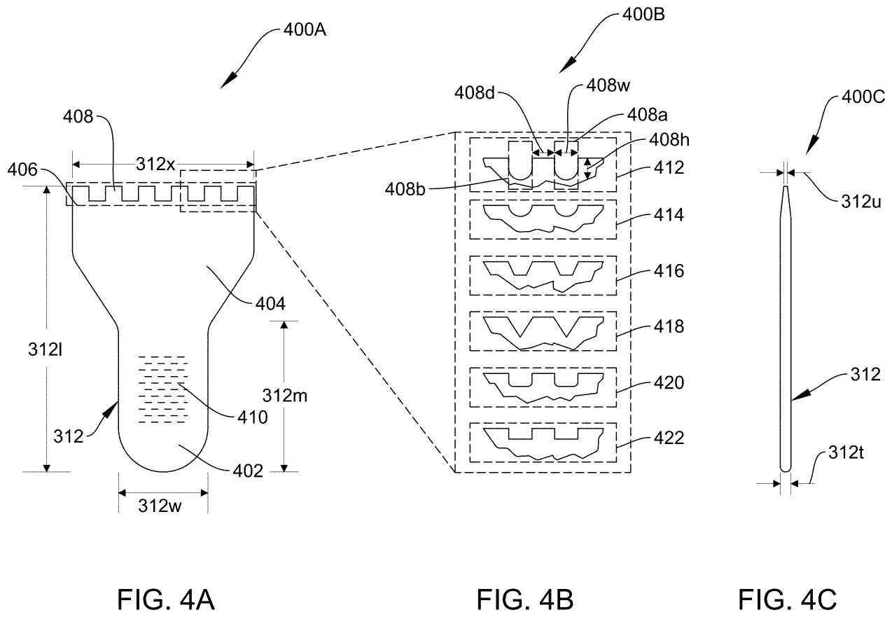

FIG. 3 depicts a lubricant applicator kit 300 that encloses a plurality of kit members, in accordance with an embodiment of the disclosure. FIG. 3 is described in conjunction with FIGS. 4A to 4C. FIGS. 4A to 4C depict different views 400A to 400C of the lubricant applicator tool 312, in accordance with an embodiment of the disclosure.

Referring to FIG. 3, the lubricant applicator kit 300 includes a storage container 302, a flexible pouch 304 containing a lubricant 306, a wiping member 308, a pair of gloves 310, a lubricant applicator tool 312, and an instructional guide 314.

The storage container 302 may correspond to a receptacle or an enclosure with a strength suitable to withstand storage, handling, and transportation, including shipment. The storage container 302 may enclose a plurality of kit members, such as the flexible pouch 304 containing the lubricant 306, the wiping member 308, the pair of gloves 310, the lubricant applicator tool 312, and the instructional guide 314, that may be protected by being inside of its structure. In accordance with an embodiment, the storage container 302 may be a corrugated fibreboard box having a defined structural design. The storage container 302 may further have other components 302a, such as a unique printed bar code, a hologram, a QR code, a label, and/or a graphic design. In accordance with an exemplary embodiment, the length of the storage container 302 and the width of the storage container 302 may range from 100 mm to 105 mm. Further, the height of the storage container 302 may range from 150 mm to 155 mm. In accordance with an exemplary scenario, the storage container 302 may be a standard 200 pound test box that may have the length and width of 4×4 inches and height of 6 inches. It should be noted that the above measurements are merely for exemplary purposes, and do not limit the scope of the disclosure.

The flexible pouch 304 may be a thin-walled plastic envelope adapted to contain a defined quantity of the lubricant 306. The flexible pouch 304 may have front and back walls of sufficient thickness, such as 0.5 and 5.0 mils. At a defined location along the edges of the flexible pouch 304, such as one of the four corners, there is provided a plastic tube or a lip projecting out, such as a spout 306a, through which the lubricant 306 can be squeezed out forcibly. The spout 306a may be temporarily sealed using a screw cap 306b. The spout 306a with the screw cap 306b may have an opening of at least 10 mm so that the lubricant 306 may be easily squeezed out from the flexible pouch 304 onto the surface of the fifth wheel 106. The remaining boundary of the front and back walls may be sealed to each other along all four edges with sufficient strength such that the flexible pouch 304 will not be severed under normal filling, packaging and transportation processes. In accordance with an embodiment, a single sheet of plastic may be folded back on itself at the bottom and heat-sealed at all the four edges. In accordance with another embodiment, the flexible pouch 304 may be injection molded from a single piece of material having no heat-sealed edges.

Though the flexible pouch 304 shown in FIG. 3 is of rectangular shape, it should not be construed to be limiting and the flexible pouch 304 may be of any other shape, i.e. round, oval, square, spherical, cylindrical, without any deviation from the scope of the disclosure. The material used for the flexible pouch 304 may be a heat sealable thermoplastic material, such as polyamides, polystyrene, polyethylene, polypropylene, polytetrafluoroethylene, ethylene-vinyl chloride copolymers, ethylene-vinyl acetate copolymers and the like. The flexible pouch 304 may be clear, translucent or may have a dye or other coloring material added thereto.

In accordance with an exemplary embodiment, the capacity of the flexible pouch 304 may be at least 500 mL. The height of the flexible pouch 304 may range from 140 mm to 150 mm. In accordance with an exemplary scenario, the flexible pouch 304 may be of 17-18 ounces (or 500 mL) capacity with the screw cap 306b. In accordance with an exemplary scenario, the height of the flexible pouch 304 may be 15 cm or less so that it can fit comfortably in the storage container 302. It should be noted that the above measurements are merely for exemplary purposes, and do not limit the scope of the disclosure.

The lubricant 306 may correspond to a synthesized substance that may be used to control (or reduce) friction and wear between the exposed surfaces of the fifth wheel 106 (of the powered vehicle 102) and the under surface plate 230 (of the unpowered vehicle 104) when the powered vehicle 102 and the unpowered vehicle 104 are coupled and in relative motion. The lubricant 306 may be a solid or semi-solid product of dispersion of a thickening agent in a lubricating oil. Examples of the solid form of the lubricant 306 may include, but are not limited to, graphite, graphene, molybdenum disulphide, and the like. Examples of the semi-solid form of the lubricant 306 may include, but are not limited to, grease.

In accordance with an embodiment, the lubricant 306 may correspond to grease that may be a semi-synthetic, diluent-type, heavy duty, and lithium extreme pressure lubricant. The lubricant 306, i.e. the grease, may be made with high viscosity index, paraffin base oils and synthetic base fluids. Using superior adhesive film forming characteristics, the lubricant 306, i.e. the grease, may tenaciously cling to plates and resist squeeze out for lasting protection. Various characteristics of the lubricant 306, i.e. the grease, may include, but are not limited to rim rust retardant, tire mounting, anti-wear, extreme pressure and load carrying capabilities. Other characterises may include, but are not limited to, resistant to rain, and snow, resistant to adhering of dirt or dust, and reduces wear. The lubricant 306, i.e. the grease, should not harden, chip, flake off or form a hard pack build-up during cold weather. The lubricant 306, i.e. the grease, may form an almost indestructible adhesive film with a cushioning effect under extreme pressure. It should be noted that the aforesaid instances are merely for exemplary purposes, and do not limit the scope of the disclosure.

The wiping member 308 may be one of a wiping cloth, a rug, a paper towel, a paper wipe, or the like, that may be used for cleaning drips-and-spills of the lubricant 306 before, during, or after lubricating the fifth wheel 106. In accordance with an exemplary embodiment, the length of the wiping member 308 may range from 300 mm to 305 mm, and the width of the wiping member 308 may range from 330 mm to 335 mm. In accordance with an exemplary scenario, the wiping member 308 may be a rectangular paper wipe with dimensions 12×13 inches and folded twice so that one side is 6 inches long and may fit easily into the storage container 302. It should be noted that the above measurements are merely for exemplary purposes, and do not limit the scope of the disclosure.

The pair of gloves 310 may be worn by the user in order to keep the user's hand as clean as possible before, during, and after the lubrication of the fifth wheel 106. The user may be a driver, an owner, a mechanic, or an automobile professional handling the powered vehicle 102 and the unpowered vehicle 104. The pair of gloves 310 may be disposable and one-time-use. Examples of the pair of gloves 310 may include, but are not limited to, polyethylene, latex, nitrile, neoprene, or vinyl gloves.

The lubricant applicator tool 312 may be a disposable plastic applicator that may be used for uniformly applying the lubricant 306, i.e. the grease, on the fifth wheel 106. In accordance with an embodiment, the lubricant applicator tool 312 may be made in one piece of injection molded plastic. The structural design of the lubricant applicator tool 312 may be such that it facilitates the user to spread the lubricant 306, i.e. the grease, easily around on the top surface 204 of the fifth wheel 106.

As depicted in FIG. 4A, the lubricant applicator tool 312 may comprise a handle portion 402, an operative portion 404, a working edge 406, and a plurality of indentations 408. The operative portion 404 may extend out from a defined length 312m of the handle portion 402. The operative portion 404 may comprise the working edge 406 equipped with the plurality of indentations 408. The plurality of indentations 408 may include multiple indentations that are identical and evenly spaced. In accordance with an embodiment, the width 408w and height 408h of each indentation, such as the first indentation 408a, may range from preferably from 5 mm to 8 mm and more preferably from 6.3 mm to 6.4 mm. The plurality of indentations 408 may correspond to serrated teeth that are for the purpose of spreading the lubricant 306, i.e. the grease, easily around on the top surface 204 of the fifth wheel 106.

In accordance with an embodiment, the handle portion 402 may have a length 312m and a first width 312w in a portion that is held by the user. At the defined length 312m of the handle portion 402 from a proximal end of the lubricant applicator tool 312, the width may increasingly taper out till the first width 312w becomes the second width 312x of the operative portion 404. Thus, the lubricant applicator tool 312 may have an elongated structure such that the second width 312x of the operative portion 404 remains less than the length 3121 of the lubricant applicator tool 312. The width 408w and the height 408h of the plurality of indentations 408 permits an application of the lubricant 306 in parallel beads, each spaced apart from adjacent beads by a defined distance that is substantially same as a distance 408d between two adjacent indentations, such as 408a and 408b. In accordance with an exemplary embodiment, the length 3121 of the lubricant applicator tool 312 may range from 120 mm to 130 mm, and the second width 312x of the operative portion 404 at the working edge 406 may range from 70 mm to 80 mm. The defined length 312m of the handle portion 402 may vary from 50 mm to 77 mm and the first width 312w may vary from 38 mm to 51 mm.

As depicted in a side view 400C in FIG. 4C, the first thickness 312t of the lubricant applicator tool 312 may be substantially uniform, ranging between 3 mm to 3.5 mm from the proximal end of the handle portion 402 till the operative portion 404. However, at the working edge 406, the first thickness 312t of the operative portion 404 may tapered down towards the edge at the second thickness 312u that ranges from 1 mm to 2 mm. In accordance with an exemplary scenario, the length 3121 of the lubricant applicator tool 312 may be 127 mm, the second width 312x of the operative portion 404 may be 76 mm, the first thickness 312t at the handle portion 402 and the operative portion 404 may be 3.175 mm and the second thickness 312u at the working edge 406 may be 1.5875 mm. It should be noted that the above measurements are merely for exemplary purposes, and do not limit the scope of the disclosure.

It should be noted that the shape of each of the plurality of indentations 408, as depicted in a first view 400A in FIG. 4A, is merely for exemplary purposes. However, the shape of each of the plurality of indentations 408 may vary without any deviation from the scope of the disclosure. As depicted in a second view 400B in FIG. 4B, non-limiting examples of the shape of each of the plurality of indentations 408 may include, a U-shaped rounded rectangle (as depicted in a first block 412), a triangle (as depicted in a first block 414), an isosceles trapezium (as depicted in a first block 416), a semicircle (as depicted in a first block 418), a rectangle (as depicted in a first block 420), or a rectangle bordered by semi-circular corners (as depicted in a first block 422).

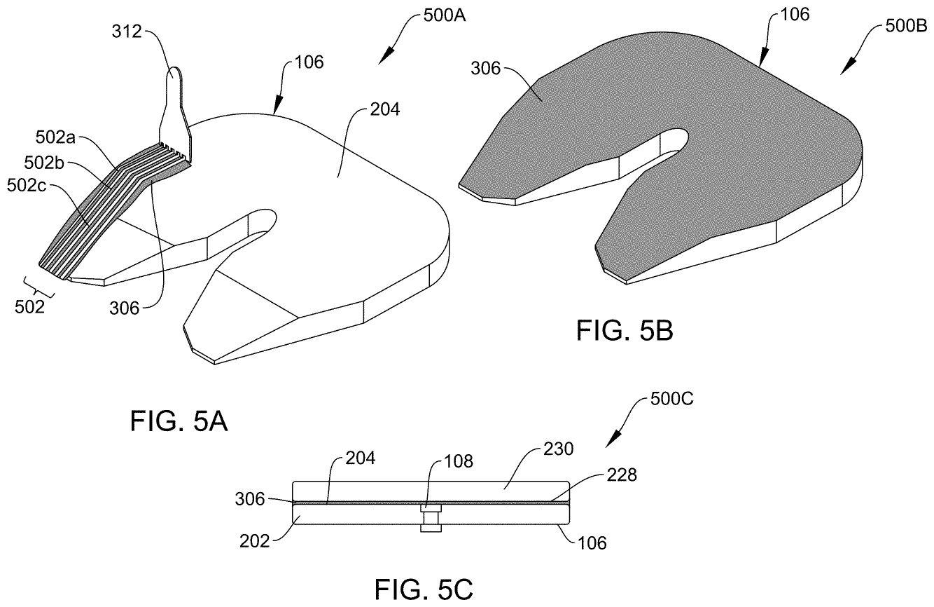

Referring to FIG. 5A, as depicted in a first perspective view 500A, the width 408w and the height 408h of each of the plurality of indentations 408 may permit the user to apply the lubricant 306 in parallel beads 502. Each bead, such as 502b, may be spaced apart from adjacent beads, such as 502a and 502c, by a distance 408d between two adjacent indentations, such as the first indentation 408a and the second indentation 408b. The width and height of each of the parallel beads 502 may be same as the width 408w and the height 408h of each of the plurality of indentations 408.

In accordance with an embodiment, the lubricant applicator tool 312 may be formed by injection molding, which is a manufacturing process for producing the lubricant applicator tool 312 by injecting molten material into a mold. Injection molding may be performed with a host of materials, such as thermoplastic and thermosetting polymers. Such material for the lubricant applicator tool 312 may be fed into a heated barrel, mixed (using a helical screw), and injected into a mold cavity, where it cools and hardens to the configuration of the cavity. The mold may be made from steel, aluminium, or the like, and precision-machined to form the features or portions of the lubricant applicator tool 312. In accordance with an embodiment, an advanced 3D printing technology may use photopolymers that do not melt during the injection molding of some lower-temperature thermoplastics and may be used for a simple injection mold.

In accordance with an embodiment, the lubricant applicator tool 312 may be formed of a synthetic plastic material. For example, the lubricant applicator tool 312 may be manufactured of a suitable thermoplastic polymeric material, such as polypropylene. Other suitable materials may include polyvinyl chloride, polytetrafluoroethylene, and the like.

In accordance with an embodiment, all corners of the lubricant applicator tool 312 apart from the working edge 406 are radiused and all edges of the lubricant applicator tool 312 are rounded. In accordance with an embodiment, the handle portion 402 may include formations 410 that may facilitate better gripping of the handle portion 402 by the user.

The instructional guide 314 may correspond to a manual that includes text and graphic elements for the primary purpose of instructing or guiding the user about step-by-step procedure of how to use the lubricant applicator kit 300. The manual may be in form of a booklet, a brochure, a leaflet, or a digital medium, such as a compact drive (CD).

The instructional guide 314 may further include significant information about specific products that must be avoided or on the other hand, certain processes to be focussed, such as cleaning of the fifth wheel 106. There may be unique materials in your fifth wheel that require special care. Failing to ignore such information may result in expensive (and preventable) damage.

FIGS. 5A to 5C depict different views 500A to 500C of the lubricant 306 applied on the top surface 204 of the fifth wheel 106, in accordance with an embodiment of the disclosure. As depicted in the first perspective view 500A in FIG. 5A, the user may squeeze out the lubricant 306 from the flexible pouch 304 onto the top surface 204 of the fifth wheel 106. Thereafter, the user may apply the lubricant 306 in parallel beads 502 by sliding the working edge 406 of the operative portion 404 of the lubricant applicator tool 312 over the lubricant 306 to form the parallel beads 502. Once the user has completely squeezed out the lubricant 306 from the flexible pouch 304 on the top surface 204 and applied the lubricant 306 thereon in parallel beads 502, the fifth wheel 106 of the powered vehicle 102 may be coupled with the king pin 108 of the unpowered vehicle 104. Resultantly, the lubricant 306 may spread evenly over the top surface 204 of the fifth wheel 106, as depicted in a second perspective view 500B in FIG. 5B. The rear view 500C in FIG. 5C may clearly depict the lubricant 306 being spread out evenly between the top surface 204 of the coupling plate 202 and the bottom surface 228 of the under surface plate 230.

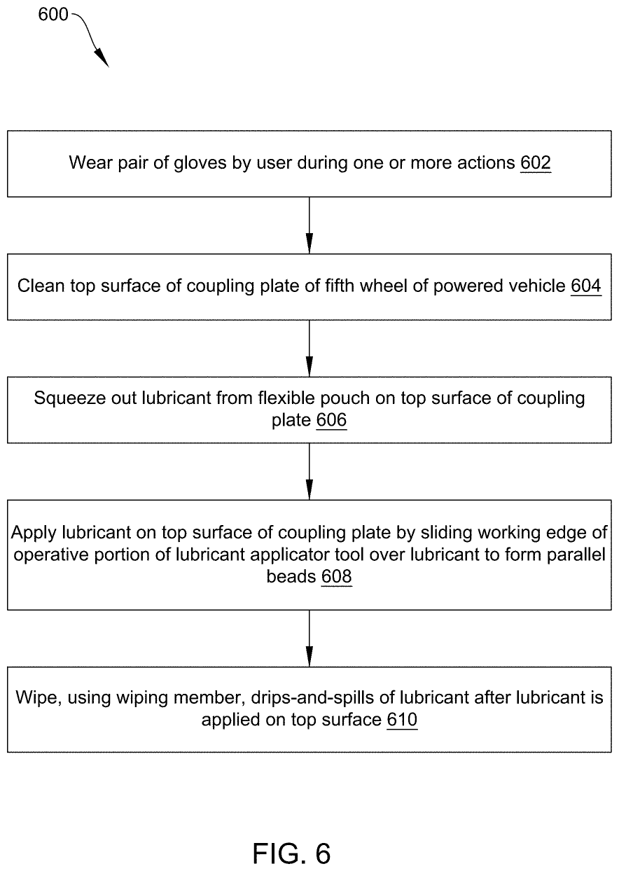

FIG. 6 depicts a flowchart 600 illustrating exemplary operations for lubricating the fifth wheel 106 of the powered vehicle 102, in accordance with an embodiment of the disclosure. FIG. 6 is described in conjunction with FIGS. 1, 2A to 2C, 3, 4A to 4C, and 5A to 5C.

At 602, the pair of gloves 310 may be worn by the user (such as a driver, a mechanic, or an automobile professional). The pair of gloves 310, from the lubricant applicator kit 300, may be worn by the user during one or more actions. The one or more actions may comprise cleaning of the top surface 204 of the coupling plate 202, squeezing out the lubricant 306 from the flexible pouch 304, and applying the lubricant 306 on the top surface 204 of the coupling plate 202, as described in following steps.

At 604, the top surface 204 of the coupling plate 202 of the fifth wheel 106 of the powered vehicle 102 may be cleaned by the user. The cleaning of the top surface 204 of the coupling plate 202 may include, scraping away as much gunk as possible with a large putty knife. The gunk may include built-up grease and other dirt and debris that may have accumulated over the time. In some cases, a degreasing compound, a soft bristle brush, and/or a steam cleaner may also be used to remove the remaining built-up grease, dirt, debris and properly clean of the top surface 204. In case small rust spots appear on the top surface 204, these may be removed by the user using a fine-grit sandpaper.

At 606, the lubricant 306 may be squeezed out of the flexible pouch 304 onto the top surface 204 of the coupling plate 202 of the fifth wheel 106 of the powered vehicle 102. The amount of the lubricant 306 contained in the flexible pouch 304 may be same as the capacity of the flexible pouch 304 may be of 17-18 (or 500 mL) ounces, which in turn, is just the sufficient quantity of the lubricant 306 to be applied on the top surface 204 of the coupling plate 202.

At 608, the lubricant 306 may be applied on the top surface 204 of the coupling plate 202 by sliding the working edge 406 of the operative portion 404 of the lubricant applicator tool 312 (lubricant applicator kit 300) over the lubricant 306 to form the parallel beads 502. Each bead, such as 502b, may be spaced apart from adjacent beads, such as 502a and 502c, by a distance 408d between two adjacent indentations, such as the first indentation 408a and the second indentation 408b, of the plurality of indentations 408 of the working edge 406. The width and height of each of the parallel beads 502 may be same as the width 408w and the height 408h of each of the plurality of indentations 408 of the working edge 406.

Once the user has applied the lubricant 306 in the parallel beads 502 on the top surface 204 of the coupling plate 202, as depicted the first perspective view 500A in FIG. 5A, the fifth wheel 106 of the powered vehicle 102 may be coupled with the king pin 108 of the unpowered vehicle 104. Resultantly, the lubricant 306 may spread evenly over the top surface 204 of the fifth wheel 106, as depicted in the second perspective view 500B and the rear view 500C in FIGS. 5B and 5C, respectively.

At 610, using the wiping member 308 from the lubricant applicator kit 300, the drips-and-spills of the lubricant 306 may be wiped off after the lubricant 306 is applied on the top surface 204 of the fifth wheel 106.

The embodiments provide for several advantages over the prior art. For example, the lubricant applicator kit 300 provides bag-in-a-box concept by means of a storage container 302 that is combined with contents, such as the flexible pouch 304 containing the lubricant 306, the wiping member 308, the pair of gloves 310, the lubricant applicator tool 312, and the instructional guide 314, that have never been packaged together before. The lubricant applicator tool 312 has a defined spacing and depth of each of the plurality of indentations 408 designed to take a raw 20 mm bead of the lubricant 306 and spread out the lubricant 306 evenly (or uniformly) and to an exact 0.25 inches depth and width over the top surface 204 of the fifth wheel 106. Such a quantity is neither too less that the top surface 204 of the fifth wheel 106 is insufficiently lubricated, nor too much that an excess of the lubricant 306 spills out and getting wasted. The quantity of the lubricant 306 provided in the lubricant applicator kit 300 is just sufficient and the method of application of the lubricant 306 on the top surface 204 is just efficient to properly lubricate the fifth wheel 106 and get the maximum service life. The lubricant applicator kit 300 is very quick, effortless, clean, convenient, safe and time saving.

While the invention has been described in terms of exemplary embodiments, it is to be understood that the words that have been used are words of description and not of limitation. As is understood by persons of ordinary skill in the art, a variety of modifications can be made without departing from the scope of the invention defined by the following claims, which should be given their fullest, fair scope.

What is claimed is:

1. A lubricant applicator tool, comprising:
a handle portion with a first width and a defined length; and,
an operative portion extending out from the defined length of the handle portion such that a second width of the operative portion remains less than a length of the lubricant applicator tool,
wherein the operative portion comprises a working edge equipped with a plurality of indentations that are identical and evenly spaced, a width and a height of each indentation ranging from 5 mm to 8 mm,
wherein the width and the height of each of the plurality of indentations permits an application of a lubricant in parallel beads, each spaced apart from adjacent beads by a defined distance that is substantially same as a distance between two adjacent indentations.

2. The lubricant applicator tool according to claim 1, wherein the lubricant applicator tool is formed by injection molding.

3. The lubricant applicator tool according to claim 1, wherein the lubricant applicator tool is formed of a synthetic plastic material.

4. The lubricant applicator tool according to claim 1, wherein the lubricant applicator tool is in an elongated shape such that the length of the lubricant applicator tool is greater than a width of the lubricant applicator tool.

5. The lubricant applicator tool according to claim 4, wherein the length of the lubricant applicator tool ranges from 120 mm to 130 mm, and wherein the width and the height of each indentation ranges from 6.3 mm to 6.4 mm.

6. The lubricant applicator tool according to claim 1, wherein the second width of the operative portion at the working edge ranges from 70 mm to 80 mm.

7. The lubricant applicator tool according to claim 1, wherein the lubricant applicator tool has a thickness that ranges from 3 mm to 3.5 mm.

8. The lubricant applicator tool according to claim 1, wherein the working edge of the operative portion is tapered down towards an edge at a thickness that ranges from 1 mm to 2 mm.

9. The lubricant applicator tool according to claim 1, wherein all corners of the lubricant applicator tool apart from the working edge are radiused and all edges of the lubricant applicator tool are rounded.

10. The lubricant applicator tool according to claim 1, wherein the handle portion includes formations that facilitate gripping of the handle portion by a user.

11. A lubricant applicator kit, comprising:
a storage container adaptable to enclose a plurality of kit members, the plurality of kit members comprising:
a lubricant for lubricating a fifth wheel of a powered vehicle;
a flexible pouch with a screw cap, the flexible pouch adapted to contain a defined quantity of the lubricant;
a wiping member for cleaning drips-and-spills of the lubricant;
a pair of gloves adaptable to be worn by a user; and,
a lubricant applicator tool comprising a handle portion and an operative portion extending out from the handle portion, the operative portion comprising a working edge equipped with a plurality of indentations,
wherein the width and the height of the plurality of indentations permits an application of the lubricant in parallel beads, each spaced apart from adjacent beads by a defined distance that is substantially same as a distance between two adjacent indentations.

12. The lubricant applicator kit according to claim 11, wherein a storage container length and a storage container width range from 100 mm to 105 mm,
wherein a storage container height ranges from 150 mm to 155 mm,
wherein the width and the height of each indentation of the lubricant applicator tool ranges from 6.3 mm to 6.4 mm.

13. The lubricant applicator kit according to claim 11, wherein the pair of gloves is formed of plastic or latex material.

14. The lubricant applicator kit according to claim 11, wherein a wiping member length ranges from 300 mm to 305 mm,
wherein a wiping member width ranges from 330 mm to 335 mm,
wherein the wiping member is one of a wiping cloth, a rug, a paper towel, a paper wipe with multiple folds.

15. The lubricant applicator kit according to claim 11, further comprising an instructional guide for the user.

16. The lubricant applicator kit according to claim 11, wherein the lubricant is a solid or semi-solid product of dispersion of a thickening agent in a lubricating oil and corresponds to a rim rust retardant and tire mounting lubricant.

17. The lubricant applicator kit according to claim 11, wherein a spout of the flexible pouch is at least 10 mm,
wherein a capacity of the flexible pouch is at least 500 mL, and
wherein a flexible pouch height ranges from 140 mm to 150 mm.

18. The lubricant applicator kit according to claim 11, wherein the plurality of indentations are identical and evenly spaced and having width and a height of each indentation ranging from 5 mm to 8 mm, and wherein a shape of the plurality of indentations is one of a U-shaped rounded rectangle, an isosceles triangle, an isosceles trapezium, a semicircle, a rectangle, or the rectangle bordered by semi-circular corners.

19. A method for lubricating a fifth wheel of a powered vehicle, the method comprising:
cleaning a top surface of a coupling plate of the fifth wheel of the powered vehicle;
squeezing out a lubricant from a flexible pouch on the top surface of the coupling plate; and,
applying the lubricant on the top surface of the coupling plate by sliding a working edge of an operative portion of a lubricant applicator tool over the lubricant to form parallel beads, each spaced apart from adjacent beads by a distance between two adjacent indentations of a plurality of indentations of the working edge.

20. The method according to claim 19, further comprising:
wearing a pair of gloves by a user during one or more actions,
wherein the one or more actions comprise cleaning of the top surface of the coupling plate, squeezing out of the lubricant from the flexible pouch, and applying of the lubricant on the top surface; and,
wiping, using a wiping member, drips-and-spills of the lubricant after the lubricant is applied on the top surface.
